(19) United States
(12) Patent Application Publication
(10) Pub. No.: US 2026/0211674 A1
(43) Pub. Date: Jul. 23, 2026

(54) DOCUMENTATION GENERATION API FOR APPLICATION CODE IN DISTRIBUTED DEVELOPMENT ENVIRONMENTS

(71) Applicant: SAP SE, Walldorf (DE)

(72) Inventors: Sevdiye Linnhoff, Heidelberg (DE); Cristina Buchholz, Reilingen (DE); Mikhail Yakovlev, Karlsdorf-Neuthard (DE); Leon Knorr, Waghäuse (DE)

(21) Appl. No.: 19/035,109

(22) Filed: Jan. 23, 2025

(51) Int. Cl. G06F 8/73; G06F 8/41; G06F 8/65

(52) U.S. Cl. CPC G06F 8/73; G06F 8/42; G06F 8/65

(57) ABSTRACT

A computer-implemented system, includes: an application programming interface (API) generating a request to complete code documentation for a source code including code entities and a software code suggestion system. The software code suggestion system processes the request to identify a code type of the source code by performing a syntax analysis and a semantics analysis of a structure of the code entities. The software code suggestion system retrieves a matching code for the source code corresponding to the code type of the source code. The software code suggestion system retrieves a context of the matching code for the source code. The software code suggestion system generates a prompt using the matching code and the context. The software code suggestion system provides the prompt to a large language model of the large language model type to generate a response including a code documentation.

### TECHNICAL FIELD

The present disclosure relates to source code analysis. More particularly, implementations of the present disclosure are directed to generation of code documentation for code under development in a distributed development environment.

### BACKGROUND

Application programing interfaces (APIs) can create comprehensive documentation for codebases, including explanations of functions, classes, and modules to assist software code development. While APIs are compatible with the local development environment, the generated code documentation can still be rejected due to some inherent limitations. For example, generated code documentation can be rejected due to inaccuracy and irrelevance to the code. Sophisticated algorithms that can analyze code patterns can generate accurate documentation for codebases that are relevant to respective code portions. Some of the developed sophisticated algorithms that provide accurate code documentation present a notable delay or trigger interruptions that makes the usage of the code documentation impractical.

### SUMMARY

Implementations of the present disclosure are directed to techniques and tools for source code analysis. More particularly, implementations of the present disclosure are directed to generation of code documentation for code under development in a distributed development environment.

In some implementations, a computer-implemented system includes: an application programming interface (API) generating a request to complete code documentation for a source code, the source code including code entities and a software code suggestion system coupled to the API. The software code suggestion system (including a documentation generation API) processing the request to identify a code type of the source code by performing a syntax analysis and a semantics analysis of a structure of the code entities. The software code suggestion system retrieves a matching code for the source code corresponding to the code type of the source code. The software code suggestion system retrieves a context of the matching code for the source code. The software code suggestion system generates a prompt using the matching code and the context, the prompt being formatted for a large language model type. The software code suggestion system provides the prompt to a large language model of the large language model type to generate a response including a suggested code for updating the source code and a code documentation describing the suggested code.

In some implementations, a method includes: receiving, from an application programming interface, a request to complete a source code, the source code including code entities; processing the request to identify a code type of the source code by performing a syntax analysis and a semantics analysis of a structure of the code entities; retrieving a matching code for the source code corresponding to the code type of the source code ; retrieving a context of the matching code for the source code; generating a prompt using the matching code and the context, the prompt being formatted for a large language model type; and providing the prompt to a large language model of the large language model type to generate a response including suggested code for completing the source code and a code documentation describing the suggested code.

The foregoing and other implementations can each optionally include one or more of the following features, alone or in combination. In particular, implementations can include all of the following features:

In a first aspect, combinable with any of the previous aspects, the request to complete the code documentation for the source code includes an identification of the source code, based on a cursor position, object boundaries, an active selection of a portion of the source code, or a type of object. In another aspect, combinable with any of the previous aspects, the software code suggestion system set ups the request to complete the source code in a natural language including questions, criteria on a response length, or criteria on a focus of a response. In another aspect, combinable with any of the previous aspects, the source code includes a development object, complete code statements, or a subset of code statements. In another aspect, combinable with any of the previous aspects, the software code suggestion system retrieves the matching code by: identifying dependencies to the development object; and using the dependencies for dependent object retrieval. In another aspect, combinable with any of the previous aspects, the software code suggestion system retrieves the context of the matching code by identifying dependencies corresponding to the code type. In another aspect, combinable with any of the previous aspects, the software code suggestion system identifies the code type of the source code by applying code snippet analysis. In another aspect, combinable with any of the previous aspects, the software code suggestion system provides, to the API, the response including the suggested code for completing the source code. In another aspect, combinable with any of the previous aspects, the software code suggestion system identifies and reuses in definitions of the prompt a related object type, code comments and related code documentation, for generating the documentation. In another aspect, combinable with any of the previous aspects, the documentation and the definitions are asynchronously extracted.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

These and other implementations can each optionally include one or more of the following advantages. The described approach advantageously provides an efficient automatic generation of code suggestions with accurate and comprehensive documentation, based on optimized prompts for large language models (LLMs). The generated code assistants are designed to enhance code development efficiency by offering accurate and relevant code documentation with detailed relevant code explanations. The described approach enhances the performance of code assistants by automatically refining prompts for LLMs to ensure that the prompts are adjusted to a LLM type to be both concise and rich in relevant information. The described documentation generation approach leverages a highly integrated and coherent system that securely and synergistically accesses multiple available information sources for retrieving relevant data. The scalability of the described system advantageously provides efficient processing of large workloads characteristic of distributed development environments and scale effectively, accommodating numerous development environments and complex tasks without a significant drop in performance. The extracted relevant data inherently integrates information corresponding to particular code types resulting in highly relevant code suggestions. The described implementations reduce the computational overhead and latency associated with processing multiple models, while increasing the efficiency of the prompt optimization to provide code suggestions and comprehensive documentation with improved accuracy.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the subject matter of the specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example system for generation of code documentation for code under development, according to some implementations of the present disclosure.

FIG. 2 is a block diagram of an example system architecture for generation of code documentation for code under development, according to some implementations of the present disclosure.

FIG. 3 is a flowchart of an example process for generation of code documentation for code under development, according to some implementations of the present disclosure.

FIG. 4 is a block diagram of an exemplary computer system used to provide computational functionalities associated with described algorithms, methods, functions, processes, flows, and procedures, according to some implementations of the present disclosure.

Like reference numbers and designations in the various drawings indicate like elements.

### DETAILED DESCRIPTION

The present disclosure relates to generating software code documentation using large language models (LLMs). More particularly, implementations of the present disclosure are directed to generation of code documentation for code under development in a local development environment. The code assistants include an application programming interface (API) of a development environment. The API provides a common interface for a distributed development environment to request code documentation sending a state of a distributed development environment indicative of a source code under development. The code assistants further include a code suggestion system coupled to the API. The code suggestion system processes the request to identify a code type of the source code under development. The code suggestion system retrieves matching code for the source code corresponding to the code type of the source code under development. The code suggestion system retrieves a context of the matching code for the source code. The code suggestion system generates a prompt using a portion of the additional code objects. The prompt is formatted for minimizing a prompt size. The code suggestion system provides the prompt to a LLM to generate a response including a comprehensive documentation of the source code under development.

The use of LLMs to improve developer efficiency can be implemented by API based code assistants, which generate code, provide explanations for existing code, or suggest changes to code based on a state of a development environment. The state of the development environment can include the state of source code development artifacts defined in the development environment, such as data models, attributes, relationships, and data access strategies.

Most of newly developed source code development artifacts include data models that are built with core data services (CDS), an infrastructure used during software development to create an underlying data model for application services and to hide the complexity of database specifics and provided by SAP SE of Walldorf, Germany. The SAP Advanced Business Application Programming (ABAP) model provides means to declaratively capture service definitions and data models. CDS is integrated into SAP's ABAP programming language and offers features such as leveraging data dictionary semantics, consistent lifecycle management, and extensibility. Data models built with CDS include multiple code objects, such as CDS views, CDS entities, database tables, CDS tuning objects, or other artifacts. When developing an application including a CDS data model, most of the application dependencies are not replicated to a local development environment but reside in a central repository. While LLMs are designed to accurately summarize large amounts of text, traditional usage of LLMs is deficient in understanding prompt syntaxes requesting code suggestions and code documentation associated with SAP data and proprietary languages such as ABAP and CDS, failing to consider the application dependencies due to the avoided local replication.

The described approach facilitates integration of CDS dependencies on shared code objects in a central repository and provides code suggestions and code documentation in the respective distributed development environment. Addressing the limitations of LLM generated code suggestions and code documentation, the generation of code snippets of the source code under development and retrieval of additional dependent code objects associated to the code snippets facilitate optimization of LLM prompts for code explanations. The retrieval of additional dependent code objects described in the present disclosure is based on parsing the state of the distributed local development environments and selectively retrieving information from development artifacts stored in a central repository to add to the model prompt. The described approach of retrieving additional dependent code objects ensures that critical information impacting a code suggestion and code documentation at a given cursor position is known to the LLM at inference. The described approach enhances the effectiveness and accuracy of code suggestions and code documentation, optimizing the development of complex software systems in a distributed development landscape, where development code objects are shared between developers in a central repository.

The described approach provides an efficient automatic generation of LLM prompts for code suggestions and code documentation based on an enriched representation of the state of the development environment. The described frontend sends a representation of the state of the development environment to the backend, enriches the representation with additional information from the shared code objects in the central repository and formulates the prompt that is sent to the LLM. The described technical solution facilitates a multitude of possible integration possibilities with the parser, the compiler, the code completion, and the inherent check tools, resulting in a superior quality in code suggestions and code documentation. As another advantage, the prompt can be optimized according to set abstract data structures and the subsequent re-generation using a ranking model to provide enhanced adaptation to software code components with increased software security. The described automatic generation of enriched and optimized LLM prompts for code suggestions and code documentation eliminates the prerequisite for LLMs to learn to understand both source code and structural information provided in a separate format, reducing the computational overhead and latency associated with processing multiple models, while increasing the efficiency of the analysis with improved accuracy.

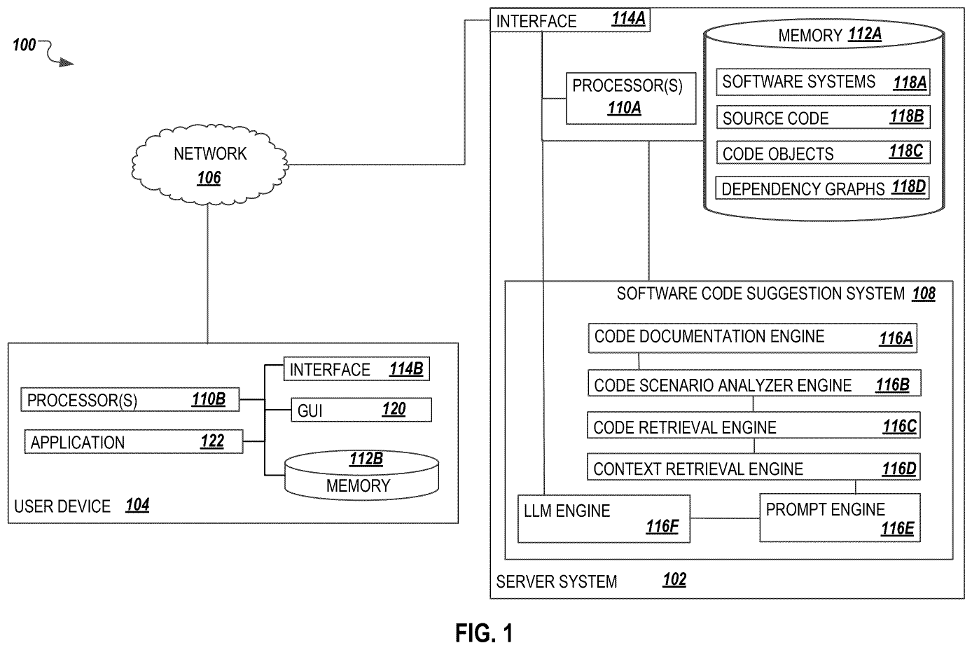

FIG. 1 is a block diagram of an example system 100 for generation of code documentation for code under development, according to some implementations of the present disclosure. Specifically, the illustrated example system 100 includes or is communicably coupled with a server system 102, an end-user device 104, and a network 106. Although shown separately, in some implementations, functionality of two or more systems or servers can be provided by a single system or server. In some implementations, the functionality of one illustrated system, server, or component can be provided by multiple systems, servers, or components, respectively.

In the example of FIG. 1, the server system 102 is intended to represent various forms of servers including, but not limited to a web server, an application server, a proxy server, a network server, and/or a server pool for a distributed development environment (e.g., a cloud-based platform like the SAP Business Technology Platform (BTP), ABAP environment). In general, server systems 102 accept requests for application services including generation of code documentation for code under development and provide such services to any number of end-user devices 104 (e.g., the user device 104 over the network 106). In accordance with implementations of the present disclosure, and as noted above, the server system 102 can host a solution environment that can be a cloud environment providing software applications, systems, and services that can be developed in multiple software development environments that share software code, collaborate on changes, and manage development processes in a distributed manner. In some instances, the server system 102 can support configuring of various tenants of different types, as well as services of different types that are integrated in customer integration scenarios and support execution of defined processes associated with generation of code documentation for code under development. For example, the server system 102 includes a software code suggestion system 108, a processor 110A, a memory 112A, and an interface 114A.

The software code suggestion system 108 can include a code documentation engine 116A, a code scenario analyzer engine 116B, a code retrieval engine 116C, a context retrieval engine 116D, a prompt generation engine 116E, and a LLM engine 116F. The software code suggestion system 108 is coupled to the processor 110A, the memory 112A, and the interface 114A for generation of code documentation for code under development using data stored in the memory 112A. The memory 112A can include software systems 118A, source codes 118B, code objects 118C, and dependency graphs 118D.

For example, user devices 104 that form software development environments generate requests for code suggestions for a software source code 118B under development compatible with the software system 118A. The software code suggestion system 108 can use the code documentation engine 116A (e.g., backend API) to request code suggestions and code documentation by sending a state of the local development environment of a respective user device 104. The code documentation engine 116A can service the code suggestion and documentation request from different integrated development environments and transmit the service request to the code scenario analyzer engine 116B. The code scenario analyzer engine 116B processes each request to identify a code scenario and code type of the source code under development. The code retrieval engine 116C can retrieve a matching code for the source code corresponding to the code type of the source code under development. The context retrieval engine 116D retrieve a context corresponding to the code type of the source code under development. The code retrieval engine 116C can send the matching code to the prompt generation engine 116E and the context retrieval engine 116D can send the context to the prompt generation engine 116E for further processing. The prompt generation engine 116E can format, using matching code, contexts, and a prompt template, a formatted prompt for the LLM engine 116F.

The LLM engine 116F can generate code suggestions and code documentation (textual descriptions) of the code suggestions associated with the code under development at the user device 104. The LLM engine 116F can be deployed as an API, facilitating integration into the development environment of the user device 104. The API deployment of the LLM engine 116F facilitates access to code suggestions in real-time. The software code suggestion system 108 can transmit the code suggestions and textual descriptions of the code suggestions to be displayed on the graphical user interface (GUI) 120 of the user device 104. For example, the software code suggestion system 108 of the present disclosure is coupled to the interface 114A to provide an integrated user interface (UI) rendering solution within a digital assistant that leverages generative LLM to infer code suggestions and documentation compatible with the software system 118A and optimize prompt display of the code suggestions for an efficient development of the software source code 118B. More particularly, the software code suggestion system 108 of the present disclosure calls the context retrieval engine 116D to leverage the ability of the prediction engines including LLM 116F to generate optimized code suggestions and documentation using an enriched prompt formatted according to the target LLM.

In general, the end-user device 104 includes an electronic computer device operable to receive, transmit, process, and store any appropriate data associated with the system 100 of FIG. 1. The end-user device 104 is intended to encompass any client computing device such as a laptop/notebook computer, wireless data port, smart phone, personal data assistant (PDA), tablet computing device, one or more processors within these devices, or any other suitable processing device. The end-user device 104 includes an interface 114B, a processor 110B, a memory 112B, and a GUIs 120. The end-user device 104 can include one or more applications 122. The application 122 can be any type of application including an application that allows a user device to develop software source code 118B with shared code objects 118C in the memory 112A serving as a central repository. The application 122 of the end-user device 104 can automatically request code suggestions and documentation during development of the software source code 118B. In some implementations, an application 122 can use parameters, metadata, and other data to access the software code suggestion system 108 from the server system 102.

In accordance with implementations of the present disclosure, the application 122 includes a digital assistant that enables interactions with the user device 104. For example, and as described in further detail herein, the digital assistant of the user device 104 can receive software code suggestions and documentation. In some examples, one or more software code suggestions with inline portions of the documentation are presented as a graphical representation in the GUI 120. In accordance with implementations of the present disclosure, the GUI 120 can present software code suggestions and documentation as a graphical representation in a popover container within a software development window. In some examples, the graphical representation can be provided as a web-based rendering using a web rendering runtime that is built into the popover container (e.g., iframe). In some examples, the graphical representation is compatible with a UI framework of the popover container. An example UI framework includes, without limitation, SAP's SAPUI5.

In some implementations, any, or all, of the components of the example system 100, both hardware or software (or a combination of hardware and software), can interface with each other or the interface(s) 114A, 114B (or a combination of both) over the network 106 for generation of code documentation for code under development. The functionality of the end-user device 104 can be accessible for all service consumers using the application 122 that transmits prompts to the software code suggestion system 108 to generate code suggestions and documentation.

For example, the end-user device 104 can include a computer that includes an input device, such as a keypad, touch screen, or other device that can accept user information, and an output device that conveys information associated with the operation of the server system 102, or the user device itself, including digital data, visual information, or a GUI 120, respectively. The GUI 120 each interface with at least a portion of the system 100 for any suitable purpose, including generating a visual representation of the application 122. The GUI 120 can provide the user with an efficient and user-friendly presentation of code suggestions with inline documentation provided by or communicated within the system. The GUI 120 can include a plurality of customizable frames or views having interactive fields, pull-down lists, and buttons operated by the user. The GUI 120 can include any suitable graphical user interface, such as a combination of a generic web browser, intelligent engine, and command line interface (CLI) that processes information and efficiently presents the results to the user visually.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems. Data exchanged over the network 106, is transferred using any number of network layer protocols, such as Internet Protocol (IP), Multiprotocol Label Switching (MPLS), Asynchronous Transfer Mode (ATM), Frame Relay, etc. Furthermore, in implementations where the network 106 represents a combination of multiple sub-networks, different network layer protocols are used at each of the underlying sub-networks. In some implementations, the network 106 represents one or more interconnected internetworks, such as the public Internet.

Each processor 110A, 110B included in the end-user device 104 can be a central processing unit (CPU), an application specific integrated circuit (ASIC), a field-programmable gate array (FPGA), or another suitable component. Each processor 110A, 110B included in the end-user device 104 executes instructions and manipulates data to perform the operations of the end-user device 104, respectively. In particular, each processor 110A, 110B included in the end-user device 104 executes the functionality required to send requests to the server system 102 and to receive and process responses from the server system 102. Each processor 110A, 110B can be a CPU, a blade, an ASIC, a FPGA, or another suitable component. Each processor 110A, 110B executes instructions and manipulates data to perform the operations of the respective system (the server system 102, the end-user device 104). Specifically, each processor 110A, 110B executes the functionality required to receive and respond to requests from the respective system (the server system 102, the end-user device 104), for example.

Interfaces 114A, 114B are used by the server system 102, the end-user device 104, respectively, for communicating with other systems in a distributed environment—including within the system 100—connected to the network 106. The interfaces 114A, 114B each include logic encoded in software and/or hardware in a suitable combination and operable to communicate with the network 106. More specifically, the interfaces 114A, 114B can each include software supporting one or more communication protocols associated with communications such that the network 106 or interface's hardware is operable to communicate physical signals within and outside of the illustrated system 100.

The memory 112A, 112B can include any type of memory or database module and can take the form of volatile and/or non-volatile memory including, without limitation, magnetic media, optical media, random access memory (RAM), read-only memory (ROM), removable media, or any other suitable local or remote memory component. The memory 112A, 112B can store various code objects or data, including caches, classes, frameworks, applications, backup data, code objects, jobs, web pages, web page templates, database tables, database queries, repositories storing static and/or dynamic information, and any other appropriate information including any parameters, variables, algorithms, instructions, rules, constraints, or references thereto associated with the purposes of the server system 102, or the end-user device 104, respectively.

There can be any number of end-user devices 104 and server systems 102 associated with, or external to, the system 100, forming a distributed development environment where software code is developed at remotely located end-user devices 104. Additionally, the example system 100 can include one or more additional user devices external to the illustrated portion of system 100 that are capable of interacting with the system 100 using the network(s) 106. Further, the term “client,” “user device,” and “user” can be used interchangeably as appropriate without departing from the scope of the disclosure. Moreover, while user device can be described in terms of being used by a single user, the disclosure contemplates that many users can use one computer, or that one user can use multiple computers. As used in the present disclosure, the term “computer” is intended to encompass any suitable processing device. For example, although FIG. 1 illustrates a single server system 102, a single end-user device 104, the system 100 can be implemented using a single, stand-alone computing device, two or more servers 102, or multiple user devices. The server system 102, and the end-user device 104 can include any computer or processing device such as, for example, a blade server, general-purpose personal computer (PC), Mac®, workstation, UNIX-based workstation, or any other suitable device. In other words, the present disclosure contemplates computers other than general purpose computers, as well as computers without conventional operating systems. Further, the server system 102 and the end-user device 104 can be adapted to execute any operating system or runtime environment, including Linux, UNIX, Windows, Mac OS®, Java™, Android™, iOS, BSD (Berkeley Software Distribution) or any other suitable operating system. According to one implementation, the server system 102 can also include or be communicably coupled with an e-mail server, a Web server, a caching server, a streaming data server, and/or another suitable server.

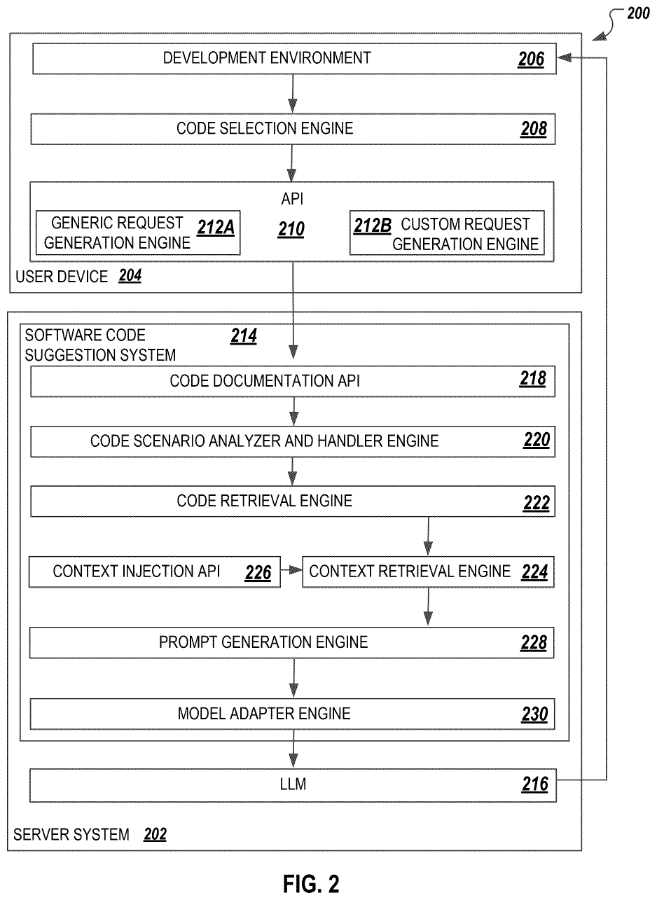

Regardless of the particular implementation, “software” can include computer-readable instructions, firmware, wired and/or programmed hardware, or any combination thereof on a tangible medium (transitory or non-transitory, as appropriate) operable when executed to perform at least the processes and operations described herein. Indeed, each software component can be fully or partially written or described in any appropriate computer language including C, C++, Java™, JavaScript®, Visual Basic, assembler, Perl®, ABAP, ABAP OO (Object Oriented), any suitable version of fourth-generation programming language (4GL), as well as others. While portions of the software illustrated in FIG. 1 are shown as individual modules that implement the various features and functionality through various code objects, methods, or other processes, the software can instead include multiple sub-modules, third-party services, components, libraries, and such, as appropriate. Conversely, the features and functionality of various components can be combined into single components as appropriate. The communication between the end user device 104 and the server system 102 can include several different communication protocols configured to optimize generation of code documentation for code under development, as further described in detail with reference to FIGS. 2-4.

FIG. 2 is a block diagram of an example system architecture 200 for generation of code documentation for code under development, according to some implementations of the present disclosure. The example system architecture 200 includes a server system 202 (e.g., server system 102 described with reference to FIG. 1) and one or more user devices 204 (e.g., user device 104 described with reference to FIG. 1).

The user device 204 includes a development environment 206, a code selection engine 208, and an API 210. In some implementations, the user device 204 includes WebSockets to provide a persistent connection between the user device 204 and the server system 202, facilitating real-time data exchange. The WebSockets can provide immediate context updates, for collaborative code development environments. The API 210 includes a generic request generation engine 212A and a custom request generation engine 212B. The user device 204 can generate source code files within the development environment 206. The code selection engine 208 can monitor the source code files within the development environment 206. The source code files can include new source code files generated for the software systems (e.g., software systems 118A described with reference to FIG. 1) including dependencies (e.g., cascades of dependencies) on source code objects. The code can be a complete development object, complete code statements, or a subset of code statements.

The code selection engine 208 can identify portions of a software source code under development including one or more completed code segments and missing one or more intended code segments planned to be added. The completed code segments can include parts of the code that have been fully developed, tested, and are functioning as intended. The completed code segments can include functions, classes, or modules that perform particular tasks within the software. The completed code segments can include defined dependencies on source code objects stored in a central repository. The dependent code objects can for example include code objects related through inheritance or interfaces, additional dependencies the compiler uses, external type definitions, domains, database views as well as an application context, such as natural language description of code requests or requirements, and developed object dependencies on particular queries and data.

The code selection engine 208 can identify incomplete code segments, proximal to an editing cursor. The incomplete code segments can include placeholders or partially written code that indicate where additional functionality is planned to be added. The incomplete code segments can include comments indicating planned integration of dependencies on source code objects stored in the central repository. The comments indicating planned integration of dependencies on source code objects 222 form existing documentation of the source code under development. The existing documentation includes a natural language description of planned code requests or requirements. The source code files include comments describing the source code file, the completed code segments and the intended code segments planned to be added. The documentation can be included within the source code to explain the purpose of particular sections, outline the logic, or provide instructions for future development. The documentation can include semantic information indicative of a project structure, dependencies, and configuration files corresponding to the current state of the local development environment 206. The semantic information can describe the identifiers, types, database tables, references, and relationships between the code objects in the source code of an application, as well as global system objects, such as system classes or database tables. The incomplete code segments can include generic comments or notes explaining what is planned to be implemented for source code completion. New source code files can be entirely new additions to the software systems, being stored in the memory, representing new features or components being integrated into the existing codebase. The source code files can be organized in a way that reflects the overall architecture of the software, with markers indicating separation between different components and logical groupings of related code to facilitate software development in the distributed development environment. The source code files can be organized in a way that indicates a portion of the source code and a portion of the documentation that are completed and what is planned to be developed and added to the source code.

The user device 204 can automatically generate and send requests to the code documentation API 218. In some implementations, the code that the request refers to is indicated by an identifier generated by the development environment 206. Based on the different code selections, the user device 204 can activate the generic request generation engine 212A or the custom request generation engine 212B to generate the request. The generic request generation engine 212A creates an explanation request for the code selection independent of further user interaction. In some implementations, the custom request generation engine 212B requests user inputs including user-particular requests and custom requests. The custom request generation engine 212B can process the user inputs to generate customized requests for code suggestions and documentation. The requests generated by either the generic request generation engine 212A or the custom request generation engine 212B can be set up in natural language such as questions, criteria on the response length, or criteria indicative of a focus of the response. The generic request generation engine 212A or the custom request generation engine 212B that generated the request can send the request to the code documentation API 218 of the server system 202.

The server system 202 includes a software code suggestion system 214 (e.g., software code suggestion system 108 as described with reference to FIG. 1) and a LLM 216. The software code suggestion system 214 includes a code documentation API 218 (e.g., code documentation engine 116A as described with reference to FIG. 1), a code scenario analyzer and handler engine 220 (e.g., code scenario analyzer engine 116B as described with reference to FIG. 1), a code retrieval engine 222 (e.g., code retrieval engine 116C as described with reference to FIG. 1), a context retrieval engine 224 (e.g., context retrieval engine 116D as described with reference to FIG. 1), a context injection API 226, a prompt generation engine 228 (e.g., prompt generation engine 116E as described with reference to FIG. 1), and a model client engine 230. The software code suggestion system 214 can process the request received from API 210 (e.g., backend API) to request code suggestions and code documentation by sending the request to the code documentation engine 218.

The code documentation API 218 of the software code suggestion system 214 facilitates secure access to the frontend API 210, verifying the identity of the requesting environment development environment 206. The code documentation API 218 provides a common interface for the local development environment 206 to request code suggestions and code documentation during software code development on the user device 204. The code documentation API 218 can communicate with the frontend API 210 to collect the current state of the local development environment 206, including open files, cursor position, and recent edits. The code documentation API 218 can transmit the code suggestion and documentation request from different integrated development environments and the service request to the code scenario analyzer engine 220.

The code scenario analyzer engine 220 processes each request to identify a scenario type and to determine additional resources corresponding to the scenario type that can be queried to retrieve relevant information. The scenario types include a request for a code suggestion, a request for a method implementation, a request for a method definition, a request for a function implementation or a request for an action or validation of a code object. The scenario types also differentiate in requests for class, class definition, and/or class implementation. The code scenario analyzer engine 220 analyzes and parses the code portion under development in the local development environment 206 provided by the code documentation API 218 to generate a parsed code snippets including information extracted to improve the LLM prompt. The code scenario analyzer engine 220 analyzes each request by performing a syntax analysis and a semantics analysis to determine the code structure and a comprehensive understanding of the code under development. The code scenario analyzer engine 220 converts the extracted the code structure and meaning of the code under development into a scenario including a code type of the source code under development that can be processed by the code retrieval engine 222 and the context retrieval engine 224.

The code retrieval engine 222 can retrieve a matching code for the source code corresponding to the code type of the source code under development. For requests related to method implementation, the code retrieval engine 222 retrieves relevant code snippets, examples of standardized practices, and documentation to assist in writing the method. For method definitions the code retrieval engine 222 retrieves templates, parameter suggestions, and examples based on the project's coding standards. For function implementation scenarios, the code retrieval engine 222 retrieves code examples, optimization tips, and relevant library functions. For actions or validations, code retrieval engine 222 retrieves validation rules, error handling practices, and integration points within the codebase.

The context retrieval engine 224 retrieves a context corresponding to the code type of the source code under development. The context retrieval engine 224 can process the scenario types identified by the code scenario analyzer engine 220, to retrieve additional content and context corresponding to the code scenario type of the source code under development. For example, the context retrieval engine 224 can identify dependencies to other development code objects. Context can be retrieved by making use of a context injection API 226 that is not part of the code documentation API 218. Further context is retrieved that is not provided by the context injection API 226. The additional retrieved context depends on the code type and additional code (e.g., retrieving the class definition) as context. The code retrieval engine 222 can send the matching code to the prompt generation engine 228 and the context retrieval engine 224 can send the context to the prompt generation engine 228 for further processing.

The prompt generation engine 228 can format, using the matching code, the contexts, and a prompt template, a formatted prompt for the LLM 216. The prompt generation engine 228 fetches the additional information from identified additional resources in the memory. The prompt generation engine 228 processes and filters the retrieved information to generate filtered information to be included in the prompt sent to the LLM 216. The prompt generation engine 228 can filter the retrieved information according to the identified scenario type. The prompt generation engine 228 can generate, using the scenario type, the filtered additional information, and a prompt template, a prompt for the LLM 216. For example, for each query corresponding to a scenario type, a prompt having a particular format defined by the prompt template is generated, by the prompt generation engine 228. The prompt generation engine 228 can optimize the prompt by creating a ranked list of pieces of information from the filtered additional information. The inherent ranking of the filtered additional information facilitates the prioritization of the most relevant information. The prompt generation engine 228 can optimize the prompt by filling a context window. For example, the ranked list of information is used to fill the context window. The ranked information is added to the context in order of priority until the context window is full.

The model adapter engine 230 can format, using guidelines of a target LLM 216, a formatted prompt for the LLM 216. In some implementations, the guidelines are tested for different LLMs based on performance measurements. The test results are used to generate a relationship between guidelines for prompt formats and target LLMs. The prompt generation engine 228 can include a code generator, which can generate context in a common structural format such as JavaScript Object Notation (JSON) or extensible markup language (XML).

The LLM 216 can process the prompt formatted according to respective guidelines and additional input data (e.g., context data) to generate source code suggestions and code documentation. The generated source code suggestions and the code documentation include textual descriptions of code entities formatted according to a programming language associated with the language used in the source code file. The LLM 216 can send the source code suggestions and the code documentation to the respective user device 204A, 204B that generate the code suggestion request and the code documentation. The LLMs can include GPT 35 TURBO, GPT 35 TURBO-16K, GPT-4, or GPT-4-32K or self-trained large language models.

The LLM 216 can be trainable on vast quantities of code entities (e.g., thousands of classes). The training of the LLM 216 can include contextual training, the prompt generation engine 228 providing clear context for the code suggestions and the code documentation. The training of the LLM 216 exposes the LLM 216 to enriched contexts during training, facilitating the LLM 216 to learn to work with more comprehensive prompts. The training of the LLM 216 trains the LLM 216 to understand that prompts can include more information than just the immediate snippets, improving the ability of the LLM 216 to generate responses based on richer contexts.

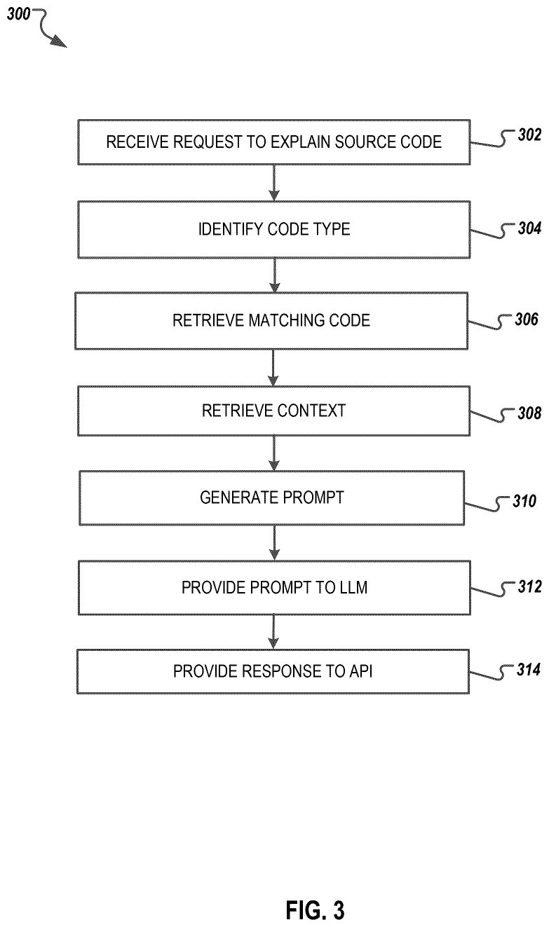

For example, a prompt can include comments or descriptions that specify a target functionality or constraints. The LLM 216 uses the context windows to generate code suggestions and code documentation that are coherent and contextually appropriate for the source code under development. In some implementations, the LLM 216 can includes a post-processor that mitigates a risk of LLM hallucinations and to improve formatting of the response from the LLM (e.g., based on a format chosen in a communication schema). Current LLMs are usually much more sensitive to information included in the beginning (prefix) or in end (suffix) of the prompt. Including the cursor context in the prefix or the suffix of the prompt can increase the accuracy of the code suggestions and the code documentation generated by the LLM 216. The LLM 216 transmits the generated code suggestions and code documentation to the user device 204 for real-time display within the development environment 206. Further details regarding the design and operation of the software code suggestion system 214 are described in concurrently filed patent application ______ filed on ______, by SAP SE, which is hereby incorporated by reference in its entirety. Further details regarding the generation of code documentation for code under development, executed by the software code suggestion system 214, are provided with reference to FIG. 3.

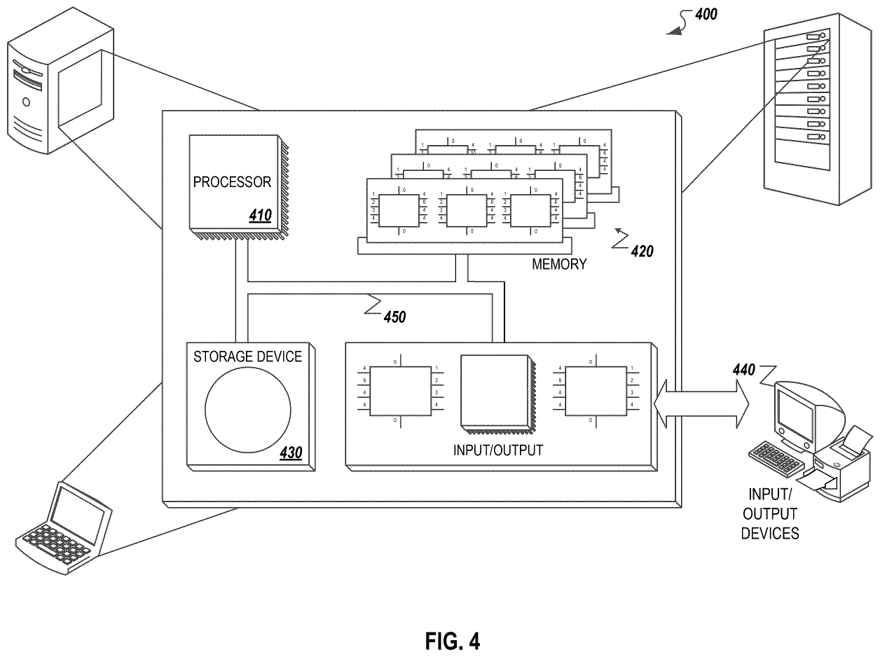

FIG. 3 is a flowchart of an example process 300 for generation of code documentation for code under development, according to some implementations of the present disclosure. The example process 300 can be performed by any component of the example system 100, described with reference to FIG. 1 or the example system architecture 200, described with reference to FIG. 2 or the example computing system 400, described with reference to FIG. 4. For clarity of presentation, the description that follows describes the example process 300 in the context of the systems described with reference to FIGS. 1, 2, and 4.

At 302, a request to complete a portion of documentation for a source code under development is received, by one or more processors. The request to complete the source documentation includes a generic documentation request or a custom request. The request to complete the source documentation can be set up in a natural language including questions, defining criteria on a response length, or criteria on a focus of a response. In some implementations, the source documentation request includes an identifier the development environment to facilitate retrieval, by a backend API, of a state of the development environment or the source code. The source code can include software products (e.g., multiple open-source software (OSS) components which are built by independent software product providers), such as a development object, complete code statements, or a subset of code statements. The source code includes code snippets (e.g., small, reusable pieces of code that can be inserted into larger programs) and one or more code entities (e.g., complex and structured components of a codebase), such as classes, methods, variables, and database tables. The portion of a source code under development can include a segment of the source code within a set window (defined based on a number of code snippets) from a cursor. The state of the development environment including the source code can be retrieved in real time, by the backend API.

At 304, a code type of the source code under development is identified, by the one or more processors. Identifying the code type of the source code under development includes applying a code snippet analysis to extract relevant snippets from a developed code portion proximal to the cursor position within the development environment. The code snippet analysis includes parsing the code to generate a parsed code that includes keywords, operators, identifiers, and other syntactic elements. The code snippet analysis can include filtering out any syntactically incorrect code snippets. The identification and removal of code snippets ensures that only valid code is considered for further processing. The code snippet analysis further includes fill-in-the-middle tasks to fill in gaps between the code snippets. The code snippet analysis can include pattern matching techniques to compare the filtered code snippets with known patterns of different programming languages and coding objectives for identifying the language and type of code based on its structure and syntax.

At 306, a matching code for the source code corresponding to the code type of the source code under development is retrieved, by the one or more processors. Retrieving the matching code includes identifying dependencies to the development object and using the dependencies for dependent object retrieval. The code type of the source code under development is processed, by the one or more processors, to determine corresponding databases including additional code objects associated to code objects of the source code under development identified by the dependencies of the source code. The additional code objects include inheritance related objects or interface related objects, compiler related objects, or externally defined object types, domain related objects. The additional code objects associated to code objects of the source code under development are retrieved from additional resources by the one or more processors. Retrieving, from the corresponding databases, the additional code objects associated to code objects of the source code under development includes performing a plurality of retrieval operations for cascades of code object dependencies.

At 308, a context of the matching code for the source code is retrieved, by the one or more processors. The context of the code under development defines the environment and circumstances surrounding the creation and modification of the code. The context of the code under development includes identifiers of the project scope, project requirements, the system architecture, the development environment, coding standards, coding conventions, code dependencies, code integrations, previous code and documentation, testing, and debugging. Retrieving the context of the matching code includes initializing a context injection API configured with project settings. The context injection API retrieves the context for the respective code type corresponding to a particular a programming language (e.g., Python, JavaScript) or a specific framework (e.g., React, Django). The context retrieval can also include processing any additional parameters or filters that can optimize the context retrieval.

In some implementations, a dependency graph is generated, by the one or more processors, using a dependency graph engine that parses the additional code objects and, along with the respective dependencies, constructs the graph by extracting each code entity accordingly. The dependency graph exposes relations and dependencies between the code entities. Each node of the dependency graph represents a code entity (code snippet), while each edge represents a dependency between two code entities. The dependency graph can include a multi-directional including mutual dependencies between nodes. A portion of the code entities of the dependency graph is filtered, by the one or more processors, to reduce a size of the dependency graph. The filtering process can include identifying and removing nodes of the dependency graph that represent unused code entities. The unused code entities can be code snippets, such as functions, classes, or variables that are defined but never called or referenced within the developed source code. The filtering process can include removal of edges that represent redundant or unnecessary dependencies. For example, if a dependency is only used in a test environment, it can be considered irrelevant for the main application. The filtering process can include application of ranking (based on a relevance to a query code entity) or any custom rules particular to the project or domain. For example, deprecated code entities or dependencies that are marked for removal can be filtered out.

In some implementations, the dependency graph is minimized by using the filtered and ranked list of code snippets or code entities and a context of the query code entity for generating a minimized dependency graph. Minimizing the dependency graph includes traversing the dependency graph beginning with the node of the query entity and iteratively estimating the required budget of an entity and adding the most relevant ones, which fit the remaining budget to the context until the token limit is reached. Minimizing the dependency graph includes selection of the most relevant parts of the context, relative to the token limit of the currently used LLM. It is determined, by the one or more processors, whether the minimized dependency graph is within limits to ensure, that the token limits of the LLM are not exceeded, while still providing the most relevant context information. In response to determining, by the one or more processors, that the minimized dependency graph exceeds the limits, the dependency graph can be further minimized until determining, by the one or more processors, that the minimized dependency graph is within limits.

At 310, a prompt is generated, by the one or more processors, using a portion of the additional code objects. For example, the prompt can be generated by converting the minimized dependency graph into a prompt format processable by a large language model to generate matching code for the source code under development. The prompt can be generated into a format that can be used by the large language model, such as JSON or actual code, using the minimized dependency graph and a prompt template. In some implementations, the prompt includes as a prefix or as a suffix a portion of the source code proximal to the cursor to facilitate generation of relevant code suggestions relative to a cursor position within the source code under development and corresponding code documentation. The prompt can include a request to generate a matching code for the source code under development according to a source code context and cursor context. In some implementations, the prompt is validated, by the processor, by processing the one or more requirements. The prompt can include an identification and reusage of related object type definitions, code comments and related code documentation retrieved from multiple potential libraries, even beyond system boundaries. The relevant documentation and definitions are asynchronously extracted to achieve better performance. Validation of the prompt by processing the one or more textual includes a verification of context requirements according to fields of the prompt template. The validation can be executed according to one or more conditions defining a minimum number of textual requirements to be included to enable processing of the request, such as inclusion in the request of at least a use-case for the requested code suggestion, a minimum number of rows within the cursor context, context inclusion, and at least one target platform or system. In some implementations, in response to determining that the prompt is missing at least one textual requirement, the process returns to receiving source code.

At 312, the prompt is provided to the LLM to generate source code suggestions and code documentation. The LLM can process the prompt and the additional input data (e.g., context data) to produce source code suggestions (textual descriptions of code entities formatted according to a programming language associated with the language used in the source code file) and corresponding code documentation. The LLM uses the context windows to generate code documentation that is coherent and contextually appropriate for the source code under development. The LLM can be trainable on vast quantities of code entities (e.g., thousands of classes) and code documentation. The training of the LLM can include contextual training. The training of the LLM can use the context windows to provide the LLM with enough information about a portion of the code surrounding a cursor within the source code under development. The LLM can be trained to retrieve the semantic information from a Python wrapper library. The training of the LLM can be aligned with inferring the semantic information from an application repository. In some implementations, the LLM can automatically apply a threat analysis to the developed source code and adjust the source code suggestions to minimize security threat vulnerabilities.

At 314, the source code suggestions and corresponding code documentation are transmitted to the user device where the source code is under development to be displayed in real time. In some implementations, the source code can be updated, by the one or more processors, to include the source code suggestions and the code documentation. For example, if a vulnerability of the source code under development is detected, the source code suggestions can be automatically included in the source code to minimize its vulnerability. The automatically added source code suggestions can include an adjustment of data flow according to a secure sequence of data transmission between the system nodes to perform secure functions. The data flow can be defined by templates indicating which components can be added. The templates can correspond to particular security communication scenarios. An application invoking a sequence of the adjusted data flow can be executed. The execution of the data flow can include retrieval of one or more APIs in the sequence of APIs from a database. The execution of the application can include generating a new API to be included in the sequence of APIs. The execution of the application can include generating an artifact matching the sequence of APIs. The execution of the application can include code generation for connection to the selected APIs to generate the data flow. The source code suggestions and, if applicable, the output of the automatically embed API calls in source code can be displayed by a graphical user interface of the user device.

The example process 300 for generation of code documentation for code under development provides an advantage of retrieving code and context based on a code type to enhance inputs for LLM prompts. The example process 300 facilitates efficient selection of most relevant context based on the relevance of the code entities to the query code entity, the code type, and the target LLM use-case. In contrast to a “one-shot-fits-all” approach, where the context is always based on the current open development tabs, the context selection of the example process 300 facilitates efficient context injection pipelines for each use-case. The described context selection can be tailored to the respective LLM requirements by using different ranking models and can filter code entities differently between LLM use-cases, increasing the accuracy of the code suggestions and corresponding code documentation generated by the respective LLM. As another advantage, the example process 300 provides a deterministic code completion solution and a service providing information about identifiers used in the code. The usage of other backend services can also be used in postprocessing the response from the LLM to correct syntax errors to improve performance of the generated code. The LLM chooses a most probable code suggestion by applying particular logic based on the information provided by the central repository and the additional backend services.

As another advantage, the example process 300 incorporates a code generation, which converts each code-entity into a “fake” code-snippet, which seamlessly blends into the original code snippet. The code generation also applies to form-based definitions that do not actually have a code equivalent. The code generation allows the example process 300 to express context information independent of code fragmentation and programming paradigms. The example process 300 also removes the necessity of the LLM to learn to understand both source code and structural information provided in a separate format. The example process 300 can include a code generator which can generate context in a common structural format such as JSON or XML. The example process 300 includes conversion of the prompt into abstract data structures and the subsequent re-generation using the ranking model that increases the versatility of the process application and the possibility of adapting the arrangement of particular code components. The example process 300 also provides an efficient way to analyze code entities for a source code under development to determine if a given code entity is associated to any security issues that require a quick response to preserve system security. The example process 300 can be executed as a time-sensitive operation, to provide ample time to update the software package and to minimize a risk of a malicious attack of vulnerable software source code components under development in the distributed development environments.

FIG. 4 is a block diagram of an example computing system 400 used to provide computational functionalities associated with described algorithms, methods, functions, processes, flows, and procedures, according to some implementations of the present disclosure. As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the software code suggestion system 108, described with reference to FIG. 1. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 can provide persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a LAN, a WAN, the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities (e.g., SAP Integrated Business Planning add-in for Microsoft Excel as part of the SAP Business Suite, as provided by SAP SE, Walldorf, Germany) or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed ASICs, FPGAs computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) can contemplate using, implementing, or executing any suitable technique for performing these and other tasks. It will be understood that these processes are for illustration purposes only and that the described or similar techniques can be performed at any appropriate time, including concurrently, individually, in parallel, and/or in combination. In addition, many of the operations in these processes can take place simultaneously, concurrently, in parallel, and/or in different orders than as shown. Moreover, processes can have additional operations, fewer operations, and/or different operations, so long as the methods remain appropriate.

In other words, although the disclosure has been described in terms of certain implementations and associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications can be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented system, comprising: an application programming interface (API) generating a request to complete code documentation for a source code, the source code comprising code entities; and a software code suggestion system coupled to the API, the software code suggestion system processing the request to identify a code type of the source code by performing a syntax analysis and a semantics analysis of a structure of the code entities, the software code suggestion system retrieving a matching code for the source code corresponding to the code type of the source code under development, the software code suggestion system retrieving a context of the matching code for the source code, the software code suggestion system generating a prompt using the matching code and the context, the prompt being formatted for a large language model type, and the software code suggestion system providing the prompt to a large language model of the large language model type to generate a response comprising a suggested code for updating the source code and a code documentation describing the suggested code.

Example 2. The computer-implemented system of the preceding example, wherein the request to complete the code documentation for the source code comprises an identification of the source code, based on a cursor position, object boundaries, an active selection of a portion of the source code, or a type of object.

Example 3. The computer-implemented system of any of the preceding examples, wherein the software code suggestion system sets up the request to complete the source code in a natural language comprising questions, criteria on a response length, or criteria on a focus of a response.

Example 4. The computer-implemented system of any of the preceding examples, wherein the source code comprises a development object, complete code statements, or a subset of code statements.

Example 5. The computer-implemented system of any of the preceding examples, wherein the software code suggestion system retrieves the matching code by: identifying dependencies to the development object; and using the dependencies for dependent object retrieval.

Example 6. The computer-implemented system of any of the preceding examples, wherein the software code suggestion system retrieves the context of the matching code by identifying dependencies corresponding to the code type.

Example 7. the computer-implemented system of any of the preceding examples, wherein the software code suggestion system identifies the code type of the source code under development by applying code snippet analysis.

Example 8. The computer-implemented system of any of the preceding examples, wherein the software code suggestion system provides, to the API, the response comprising the suggested code for completing the source code under development.

Example 9. The computer-implemented system of any of the preceding examples, wherein the software code suggestion system identifies and reuses in definitions of the prompt a related object type, code comments and related code documentation, for generating the documentation.

Example 10. The computer-implemented system of any of the preceding examples, wherein the documentation and the definitions are asynchronously extracted.

Example 11. A computer-implemented method, comprising: receiving, from an application programming interface, a request to complete a source code under development, the source code comprising code entities; processing the request to identify a code type of the source code under development by performing a syntax analysis and a semantics analysis of a structure of the code entities; retrieving a matching code for the source code corresponding to the code type of the source code under development; retrieving a context of the matching code for the source code; generating a prompt using the matching code and the context, the prompt being formatted for a large language model type; and providing the prompt to a large language model of the large language model type to generate a response comprising suggested code for completing the source code under development and a code documentation describing the suggested code.

Example 12. The computer-implemented method of the preceding example, wherein the request to complete the code documentation for the source code comprises an identification of the source code, based on a cursor position, object boundaries, an active selection of a portion of the source code, or a type of object.

Example 13. The computer-implemented method of any of the preceding examples, wherein the software code suggestion system sets up the request to complete the source code in a natural language comprising questions, criteria on a response length, or criteria on a focus of a response.

Example 14. The computer-implemented method of any of the preceding examples, wherein the source code comprises a development object, complete code statements, or a subset of code statements.

Example 15. The computer-implemented method of any of the preceding examples, wherein the software code suggestion system retrieves the matching code by: identifying dependencies to the development object; and using the dependencies for dependent object retrieval.

Example 16. The computer-implemented method of any of the preceding examples, wherein the software code suggestion system retrieves the context of the matching code by identifying dependencies corresponding to the code type.

Example 17. The computer-implemented method of any of the preceding examples, wherein the software code suggestion system identifies the code type of the source code under development by applying code snippet analysis.

Example 18. The computer-implemented method of any of the preceding examples, wherein the software code suggestion system provides, to the API, the response comprising the suggested code for completing the source code under development.

Example 19. The computer-implemented method of any of the preceding examples, wherein the software code suggestion system identifies and reuses in definitions of the prompt a related object type, code comments and related code documentation, for generating the documentation, wherein the documentation and the definitions are asynchronously extracted.

Example 20. A non-transitory computer-readable media encoded with a computer program, the computer program comprising instructions that when executed by one or more computers cause the one or more computers to perform operations comprising: receiving, from an application programming interface, a request to complete a source code under development, the source code comprising code entities; processing the request to identify a code type of the source code under development by performing a syntax analysis and a semantics analysis of a structure of the code entities; retrieving a matching code for the source code corresponding to the code type of the source code under development; retrieving a context of the matching code for the source code; generating a prompt using the matching code and the context, the prompt being formatted for a large language model type; and providing the prompt to a large language model of the large language model type to generate a response comprising suggested code for completing the source code under development and a code documentation describing the suggested code.

What is claimed is:

1. A computer-implemented system, comprising:
an application programming interface (API) generating a request to complete code documentation for a source code, the source code comprising code entities; and
a software code suggestion system coupled to the API, the software code suggestion system processing the request to identify a code type of the source code by performing a syntax analysis and a semantics analysis of a structure of the code entities, the software code suggestion system retrieving a matching code for the source code corresponding to the code type of the source code, the software code suggestion system retrieving a context of the matching code for the source code, the software code suggestion system generating a prompt using the matching code and the context, the prompt being formatted for a large language model type, and the software code suggestion system providing the prompt to a large language model of the large language model type to generate a response comprising a suggested code for updating the source code and a code documentation describing the suggested code.

2. The computer-implemented system of claim 1, wherein the request to complete the code documentation for the source code comprises an identification of the source code, based on a cursor position, object boundaries, an active selection of a portion of the source code, or a type of object.

3. The computer-implemented system of claim 1, wherein the software code suggestion system sets up the request to complete the source code in a natural language comprising questions, criteria on a response length, or criteria on a focus of a response.

4. The computer-implemented system of claim 1, wherein the source code comprises a development object, complete code statements, or a subset of code statements.

5. The computer-implemented system of claim 4, wherein the software code suggestion system retrieves the matching code by:
identifying dependencies to the development object; and
using the dependencies for dependent object retrieval.

6. The computer-implemented system of claim 1, wherein the software code suggestion system retrieves the context of the matching code by identifying dependencies corresponding to the code type.

7. The computer-implemented system of claim 1, wherein the software code suggestion system identifies the code type of the source code by applying code snippet analysis.

8. The computer-implemented system of claim 7, wherein the software code suggestion system provides, to the API, the response comprising the suggested code for completing the source code.

9. The computer-implemented system of claim 1, wherein the software code suggestion system identifies and reuses in definitions of the prompt a related object type, code comments and related code documentation, for generating the documentation.

10. The computer-implemented system of claim 9, wherein the documentation and the definitions are asynchronously extracted.

11. A computer-implemented method, comprising:
receiving, from an application programming interface, a request to complete a source code, the source code comprising code entities;
processing the request to identify a code type of the source code by performing a syntax analysis and a semantics analysis of a structure of the code entities;
retrieving a matching code for the source code corresponding to the code type of the source code;
retrieving a context of the matching code for the source code;
generating a prompt using the matching code and the context, the prompt being formatted for a large language model type; and
providing the prompt to a large language model of the large language model type to generate a response comprising suggested code for completing the source code and a code documentation describing the suggested code.

12. The computer-implemented method of claim 11, wherein the request to complete the code documentation for the source code comprises an identification of the source code, based on a cursor position, object boundaries, an active selection of a portion of the source code, or a type of object.

13. The computer-implemented method of claim 11, wherein the software code suggestion system sets up the request to complete the source code in a natural language comprising questions, criteria on a response length, or criteria on a focus of a response.

14. The computer-implemented method of claim 11, wherein the source code comprises a development object, complete code statements, or a subset of code statements.

15. The computer-implemented method of claim 14, wherein the software code suggestion system retrieves the matching code by:
identifying dependencies to the development object; and
using the dependencies for dependent object retrieval.

16. The computer-implemented method of claim 11, wherein the software code suggestion system retrieves the context of the matching code by identifying dependencies corresponding to the code type.

17. The computer-implemented method of claim 11, wherein the software code suggestion system identifies the code type of the source code by applying code snippet analysis.

18. The computer-implemented method of claim 17, wherein the software code suggestion system provides, to the API, the response comprising the suggested code for completing the source code.

19. The computer-implemented method of claim 11, wherein the software code suggestion system identifies and reuses in definitions of the prompt a related object type, code comments and related code documentation, for generating the documentation, wherein the documentation and the definitions are asynchronously extracted.

20. A non-transitory computer-readable media encoded with a computer program, the computer program comprising instructions that when executed by one or more computers cause the one or more computers to perform operations comprising:
receiving, from an application programming interface, a request to complete a source code under development, the source code comprising code entities;
processing the request to identify a code type of the source code under development by performing a syntax analysis and a semantics analysis of a structure of the code entities;
retrieving a matching code for the source code corresponding to the code type of the source code under development;
retrieving a context of the matching code for the source code;
generating a prompt using the matching code and the context, the prompt being formatted for a large language model type; and
providing the prompt to a large language model of the large language model type to generate a response comprising suggested code for completing the source code under development and a code documentation describing the suggested code.
